(19) United States
(12) Patent Application Publication
(10) Pub. No.: US 2002/0067264 A1
(43) Pub. Date: Jun. 6, 2002

(54) Tamper Evident Radio Frequency Identification System And Package

(76) Inventor: John Pius Soehnlen, Loveland, OH (US)

Correspondence Address: Gibbons, Del Deo, Dolan,, Griffinger & Vecchione, One Riverfront Plaza, Newark, NJ, 07102, US

(21) Appl. No.: 09/809,337

(22) Filed: Mar. 15, 2001

Related U.S. Application Data
(60) Provisional application No. 60/189,593, filed on Mar. 15, 2000.

(51) Int. Cl. G08B 13/14

(52) U.S. Cl. 340/572.1; 340/568.1; 340/571; 340/10.1

(57) ABSTRACT

### Abstract of Disclosure

A tamper evident package and system where the package has a radio frequency identification tag affixed to or imprinted onto the covering. An interrogator emits an electromagnetic signal to the identification tag which responds with a predetermined signal if the covering of the package is intact and has not been breached or the identification tag may be powered and emit the predetermined signal intermittently or continuously by itself. An attempt to enter the package disables the identification tag and will cause the identification tag, thereafter interrogated, to fail to send a signal or will send a signal that is different from the predetermined signal. The interrogator recognizes the lack of or the different signal as an indication that the integrity of the package has been breached.

### Cross Reference to Related Applications

The present application is based upon and claims the priority of U.S. Provisional Patent Application Serial No. 60/189,593 filed March 15, 2000 which is incorporated herein by reference.

### Background of the Invention

### Field of the Invention

This invention relates to the field of packaging, and, more particularly, to a means of determining a breach of integrity of a package.

### Description of the Related Art

There is currently a need to be able to identify when a package traveling in commerce or in storage awaiting entry into channels of commerce has been tampered with; that is, to determine that there has been a breach of the integrity of the package and entry to the contents has been achieved by an unauthorized person or by some instrumentality. Not only is there a security issue with respect to the possible pilfering of the contents of the package but there is also the possibility that the package has been opened and resealed, or that the contents have been damaged, tampered with or partially removed, either by deliberate action or by accidental means prior to receipt by the end user.

While there are numerous ways to identify when a breach of the integrity of a package has taken place, many rely upon a human inspection to perceive physical damage to the package or a change to an indicator placed on the package to evidence that breach of integrity. One difficulty with visual indicators of a breach of package is that the mischief can be done and a seal or other tampering indicator may have been replaced so as to conceal entry into the package. In addition, if a tamper-proof indicator is evident on the package, an unauthorized person may enter the package in a manner so as to defeat the purpose of the tampering indicator.

Thus, it is difficult to devise a device or system that can reliably flag a breach of the integrity of a package traveling or stored in commerce which can be employed with a large number of individual packages and yet is suitable to thwart any attempts to conceal entry into a package. Providing for the security and integrity of packages is essential for loss prevention, confidentiality and avoiding damage to the contents.

There are available radio-frequency technologies for interrogating a tag that is placed within or upon a package. Such technologies include scanners that are located at the exits of retail stores for detecting the presence of a tag on a package or goods to determine if such goods have been properly paid for by sensing that the tag was removed by the store clerk at the time of payment. If the tag has not been properly removed, an alarm is activated when the tagged item passes through a scanner and out of the store.

Such technology provides machine monitoring of unauthorized removal of items without the need for human visual inspection of each package. However, such technology is not suitable by itself to determine the breach of integrity of a package.

### Summary of Invention

The present invention relates to the employment of a radio frequency identification (RFID) system to identify when the integrity of a package has been breached. In accordance with the present invention, a tamper evident identification tag is applied to a package and a remote system interrogates the tag to verify the integrity of the package. The identification tag itself can be applied to the package in a manner such that it is visually imperceptible so that a person attempting to effect unauthorized entry into the package will not be forewarned of the presence of the tag and its use.

In carrying out the present invention, the RFID tag system comprises a plurality of components that function together to enable the tag to be interrogated and the disabling of any of the components will modify or disable the system ability to carry out a standard interrogation and response. The identification tag is applied to the package such that any intrusion into the package disables at least one of the components, thereby disabling or modifying the function of the identification tag system. Any further attempt to interrogate the tag will not result in the proper predetermined response to the interrogator. In effect, by disabling or modifying the identification tag function, the interrogation system will be unable to receive a standard response signal from the package and thus will determine, automatically and virtually without the need for direct human involvement, that there has been a breach of the integrity of the package. Accordingly, when necessary, a large number of such packages can be continuously and effectively monitored as to their integrity in a relatively short time without human intervention.

These and other features and advantages of the present invention will become more readily apparent from the following detailed description taken in conjunction with the attached drawings.

### Brief Description of Drawings

FIG. 1 is a functional schematic diagram of a radio frequency identification system usable with the present invention;

FIG. 2 is a functional overview of the present invention applied to a package; and

FIG. 3 is a diagrammatic view of the use of the present invention applied to a package.

### Detailed Description

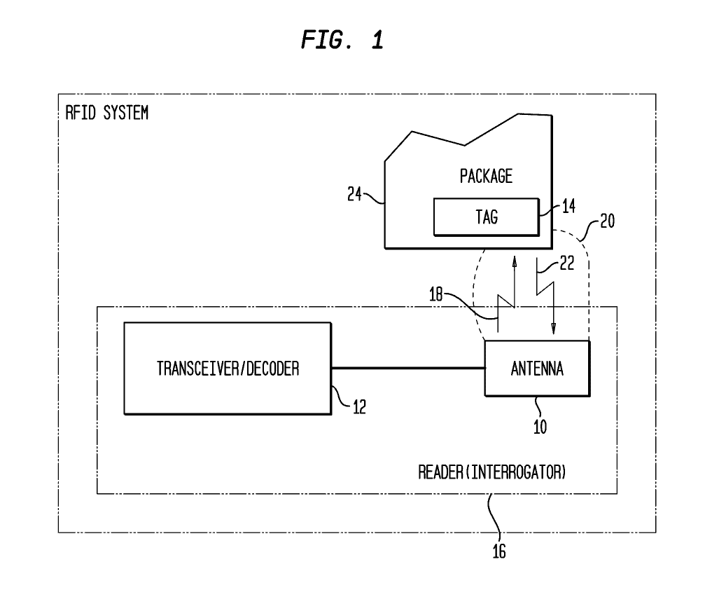

Referring to Fig 1, there is shown a functional overview of a radio frequency identification system for carrying out the purposes of the present invention. In Figure 1, the system comprises three basic components including an antenna 10, a transceiver (with decoder) 12 and a transponder or radio frequency identification tag 14 that is preprogrammed with unique information or data concerning an associated package or item. The antenna 10 emits radio signals to activate the identification tag 14 and to read and/or write data to the identification tag 14. The antenna may be any of a variety of sizes and shapes and can be built into a doorway or portal to receive signals from the identification tag 14 or from persons or things passing through the door or other portal. An electromagnetic field provided by the antenna 10 can be constantly present so that, when multiple identification tags 14 are expected continually, they may be read as they arrive. Alternatively, antenna 10 can be activated intermittently as required. If constant interrogation is not required, a sensor device can activate the field when needed.

The antenna 10 can be configured with the transceiver 12 to operate as a reader or interrogator 16 and can be configured either as a handheld or a fixed-mount device. The interrogator 16 typically emits electromagnetic radio waves 18 at wavelengths of from less than one inch to 100 feet or more, depending upon power output, the radio frequency used and the resulting necessary size of the antenna elements. When an RFID identification tag 14 passes through the electromagnetic zone 20, identification tag 14 detects the radio frequency activation signals from the interrogator 16 and responds by emitting radio waves 22 specifically to identify that particular identification tag 14. The interrogator 16 detects the data encoded in the integrated circuit of the identification tag 14 and the data is thereafter passed on to a host computer 28 for processing the information.

The RFID tag 14 itself may also be any one of a variety of shapes and sizes. RFID tags 14 may be categorized as either active or passive. Active identification tags 14 are usually powered by an internal battery and are typically read/write, that is, the data can be rewritten and/or modified. The memory of an active identification tag 14 can vary according to application requirements, that is, some systems operate with up to 1 MB of memory. In a typical read/write RFID system, an identification tag 14 can provide a set of instructions and the identification tag 14 can receive information. This encoded data then becomes part of the history of the tagged product 24. The battery-supplied power of an active identification tag 14 generally gives it longer range, however, the trade off is in the greater size, greater cost and, of course, a limited operational life. Also, with the use of an active identification tag 14, the identification tag 14, having its own source of power, may emit an intermittent or continuous signal on its own that can be read by an interrogator 16 and can therefore send out a predetermined signal indicative of the integrity of the package without the need for an interrogating signal initiating a response signal. Again, if there is a breach of the integrity of a package, the signal from the identification tag 14 can be terminated or modified by that breach to alert the interrogator of a breach of the integrity of a package.

Passive RFID tags 14 typically operate without any separate external power source and obtain operating power generated from the interrogator 16. Passive identification tags 14 thus are typically much lighter than active identification tags 14, less expensive, and offer a potentially unlimited operational lifetime. The trade off is that passive identification tags 14 typically have shorter read ranges than active identification tags 14 and require a higher-powered interrogator 16.

Read-only identification tags 14 are typically passive and are programmed with a set of data (usually 32-128 bits) that cannot be modified. Read-only identification tags 14 often operate as a key or index into a database in the same way as linear barcodes reference a database containing modifiable product-specific information.

The frequency ranges also distinguishes the various RFID systems. Low frequency (30 kHz to 500 kHz) system have short reading ranges and lower system costs. They are most commonly used in security areas, asset tracking and animal identifications. High frequency (850 mHz to 950 mHz and 2. 4 gHz to 2.5 gHz) systems offer long read ranges (greater than 90 feet) and high reading speeds.

A significant advantage of all types of RFID systems is the non-contact, non-line-of-sight nature of the technology. Identification tags 14 can be read though a variety of substances such as snow, fog, ice, paint, crusted grime and other visually and environmentally challenging conditions, where barcodes or other optical read technologies would be useless. The RFID identification tags 14 can also be read in challenging circumstances at remarkable speeds, in most cases responding in less than 100 milliseconds.

The range that can be achieved in the RFID system is essentially determined by the power available at the interrogator 16 to communicate with the identification tags 14, the power available in the identification tag to respond, and the environmental conditions and structures, the former being more significant at higher frequencies including signal to noise ratio.

Although the level of available power is the primary determinant of range, the manner and efficiency with which that power is employed also influences the range. The field or wave delivered from an antenna extends into the space adjacent to the antenna and its strength diminishes with respect to distance. The antenna design will determine the shape of the field of propagation wave delivered, so that range will also be influenced by the angle subtended between the identification tag and the antenna.

In space free of any obstructions or absorption mechanisms, the strength of the field declines in inverse proportion to the square of the distance. For a wave propagating through a region in which reflections can arise from the ground and from obstacles, the reduction in strength can vary quite considerably, in some cases, as an inverse fourth power of the distance. Where different paths arise in this way, the phenomenon is known as "multi-path attenuation". At higher frequencies, absorption due to the presence of moisture can further influence range. It is, therefore, important in many applications to determine how the environment, internal or external, can influence the range of communication. Where a number of reflective metal obstacles are to be encountered within the application to be considered, and can vary in number from time to time, it may also be necessary to establish the implications of such changes through an appropriate environmental evaluation.

Accordingly, the present invention incorporates the aforedescribed RFID technology to alleviate the problems associated with the constant monitoring of packages to determine if there has been a breach of the integrity of any package. Although the present invention will be described with respect to the shipping package integrity, the present invention is equally adaptable for use in controlled access to any suitable packaging including securing electronic devices and medical monitoring equipment and to a means of insuring that use of equipment has not been the subject of tampering. Thus, the principles of the present invention can be used for any variety of containers, boxes, or other outer coverings that are subject to pilferage or tampering and to provide a means whereby the breach of integrity of such outer covering can be detected automatically and without the continued direct need of human involvement.

The security and integrity of packages is critical for loss prevention, confidentiality and damage control. Frequently it is not obvious or evident whether a package has been opened and resealed or tampered with prior to receipt by the end user. By being able to automatically and directly monitor the integrity of a package to prevent unauthorized access to the contents of the package, tampering can be detected, thus enabling a manufacturer, distributor and/or end user to be aware of the integrity of the package or product.

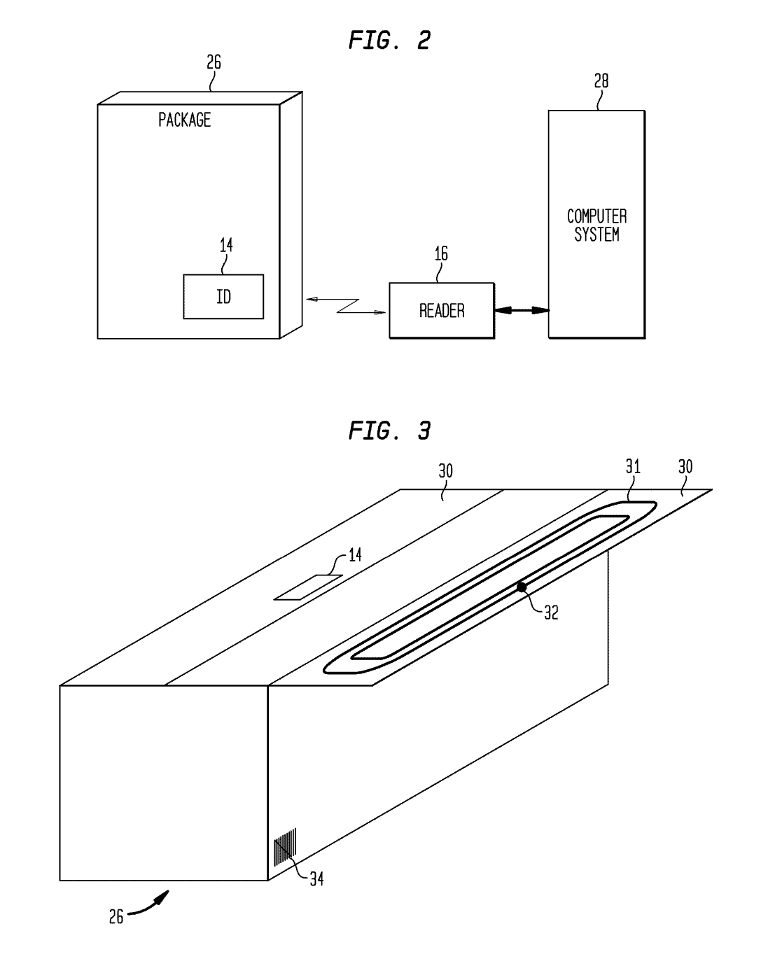

Turning now to Figure 2, there is shown a functional overview of a system employing the present invention. A package 26 is shown having emplaced thereon an identification tag 14. The identification tag 14 may be an RFID or other suitable identification tag 14. The identification tag 14 may contain encoded data corresponding to a unique product identification, such as serial number and history of the environmental conditions and location history corresponding to the package 26. The interrogator 16 interrogates the identification tag 14 by directing a radio frequency signal toward the identification tag 14 which, in turn, responds with a predetermined response signal when the outer covering or container is intact and has not been breached. Thus, the interrogator 16 receives and recognizes that predetermined signal and knows that the integrity of the package 26 has not been breached. The interrogator 16 is, in turn, coupled to a computer system 28 for processing of the information.

Turning now to Figure 3, there is shown a detailed functional overview of a tamper evident package system. The package 26 can provide information concerning the unauthorized access to the contents even if the package 26 has been resealed and no visual evidence of tampering can be seen. The package 26 contains an RFID identification tag 14 which is adapted to be disabled or modified upon the opening of the package 26. By positioning the RFID identification tag 14 across adjacent flaps 30 of the package 26, a fraction of the RFID identification tag 14 can be a part of each flap 30. Normally, the identification tag 14 spans or crosses between the flaps 24 when the flaps are in the closed, contiguous orientation having a common seal line therebetween. A conductive adhesive 32 or ink can be used to seal the flaps 30 together. When the conductive adhesive 32 is broken by opening the package 26, tampering may have occurred with the contents. While only two flaps 30 have been shown in Figure 3, there can be a plurality of sets of flaps used with the package 26 and each set of flaps may have an identification tag across any or all of the sets of flaps to carry out the purpose of the present invention. As an embodiment, where there are multiple sets of flaps, each set may have an identification tag having a differing predetermined signal such that the interrogator 16 can determine which set of flaps has been subject to a breach of integrity.

Breaking of the conductive adhesive can thus disable the identification tag 14 or change the response of the identification tag 14 response signal when interrogated by the interrogator 16. It should be noted that there may be a number of components to the identification tag 14, including thin wire conductors that may span the flaps 30, however one component of the identification tag 14 will be an antenna 31 and thus, the disabling of the antenna 31 or any of the other components will, in effect, disable the ability of the response signal to be the predetermined signal from the identification tag 14 when the identification tag 14 is properly interrogated by the interrogator 16. Again, the response signal from the identification tag 14 may be a total lack of any response signal at all or may be any changed response signal that is different than the predetermined signal emitted in response to the interrogator 16 when the outer cover of the package 26 is intact and has not been breached.

Although it is important that ultimately the antenna 31 of the identification tag 14 be disabled, there may be other components of the identification tag 14 that can be irreversibly disabled, and any one of which will prevent the antenna 31 of the identification tag 14 from returning the predetermined signal to the interrogator 16. For example, there may be various components such as sectioned antenna ports, antenna-interposer connections, chip-interposer connections and the like that may be incorporated into the function of the identification tag 14 and any one of which, if irreversibly disabled by the breach of the integrity of the package 26, would prevent the identification tag 14 from returning the predetermined signal to the interrogation signal from the interrogator 16. The components may also include the use of printed plastic or polymeric circuitry.

Components of the RFID identification tag 14, such as the antenna 31, can be printed directly on the inside of package 26 or, alternatively, printed on the outside of the package 26. The identification tag 14 may also be laminated intermediate two or more materials. The printed components can be coupled with a conductive adhesive 32 or a thin conductive element. Thus, the breaking of the conductive adhesive 32 or the thin conductive element, or the tearing apart of a laminate will disable the identification tag 14 or change its response to the radio frequency signal from the interrogator 16. The conductive adhesive must have the property that it cannot be easily re-glued or reconnected so that the identification tag 14 cannot readily be reactivated by any attempt to reseal the package 26 to conceal the breach of the integrity of that package 26.

Alternatively, the identification tag 14 can be distributed over the package or coupled to a thin conductive element that can fully surround to encompass the entire package (which may be partially or completely printed), thus providing complete tamper evidence from opening the package 26 at any potential opening. When the identification tag 14 is interrogated by an external system, a lack of response or a modified response indicates the potential of tampering.

Concealed damage and tampering can be detected and revealed in a number of ways. The information provided by the package 26 can be communicated to a remote computer system over the internet, thus enabling a shipper, manufacturer or other concerned party to monitor and track the integrity of the package 26. A bar code 34 can also be used in conjunction with the identification tag 14 to provide additional information, if needed or desired.

In view of the foregoing description, numerous modifications and alternative embodiments of the invention will be apparent to those skilled in the art. By providing a series of identification tags or a series of modifications to the interrogation response, it is possible to determine the level and degree of tampering and access to the package. Accordingly, the description is to be construed as illustrative only and is for the purpose of teaching those skilled in the art the best mode of carrying out the invention. Details of the structure maybe be varied substantially without departing from the spirit of the invention, and the exclusive use of all modifications which come with the scope of the appended claims is reserved.

Claims

1. A tamper evident package system comprising;
a package having a covering;
a radio frequency identification tag having a plurality of operative components combined to provide a predetermined signal; said identification tag being integral with said covering; and
at least one of said operative components being disabled by the breach of the integrity of said covering to modify or prevent said predetermined signal to be emitted from said identification tag.

2. A tamper evident package system as defined in claim 1 wherein said
predetermined signal is emitted in response to a radio frequency interrogation signal.

3. A tamper evident package system as defined in claim 3 wherein said plurality of operative components includes an antenna.

4. A tamper evident package system as defined in claim 1 wherein said antenna is printed onto said covering.

5. A tamper evident package system as defined in claim 3 wherein said antenna is disabled by the breach of integrity.

6. A tamper evident package system as defined in claim 1 wherein covering comprises a package having at least two flaps in an orientation to be contiguous to each other, said flaps each having a conductive material that completes an electrical connection between said flaps when in said contiguous orientation, wherein the displacement of either of said flaps out of said contiguous orientation breaks said electrical connection to disable said at least one of said operative components.

7. A tamper evident package system as defined in claim 6 wherein said conductive material is applied along mating edges of each of said flaps.

8. A tamper evident package system as defined in claim 7 wherein said conductive material is a conductive adhesive or conductive ink.

9. A tamper evident package system as defined in claim 1 wherein identification tag can be accessed by a radio frequency signal to provide information relative to the contents of the package.

10. A system to recognize a breach of integrity of a package, said system comprising;
a package having a covering;
a radio frequency identification tag having a plurality of operative components combined to emit a predetermined signal when said covering is intact, said identification tag being integral with said covering; and
a radio frequency interrogator adapted to receive the predetermined signal, and at least one of said operative components is disabled by the breach of the integrity of said covering to prevent or modify said predetermined signal emitted by said identification tag.

11. A system to recognize a breach of integrity of a package as defined in claim 10 wherein said identification tag emits said predetermined signal in response to a radio frequency interrogation signal.

12. A system to recognize a breach of integrity of a package as defined in claim 11 wherein said radio frequency interrogation signal is directed toward said identification tag by said interrogator.

13. A system to recognize a breach of integrity of a package as defined in claim 10 wherein one of said plurality of components comprises an antenna.

14. A system to recognize a breach of integrity of a package as defined in claim 13 wherein said antenna is printed onto said covering.

15. A system to recognize a breach of integrity of a package as defined in claim 10 wherein one of said operative components comprises a conductive element and where said conductive element is broken by the breach of integrity of said covering of said package.

16. A system to recognize a breach of integrity of a package as defined in claim 15 wherein said conductive element comprises a conductive adhesive.

17. A system to recognize a breach of integrity of a package as defined in claim 15 wherein said covering includes two flaps oriented contiguous to each other, each of said flaps having a portion of said conductive adhesive thereon, and wherein said conductive element is broken by the movement of either of said flaps from said contiguous orientation.

18. A method of remotely determining the integrity of a package having a covering, said method comprising the steps of:
providing a radio frequency identification tag having a plurality of components combined to provide a predetermined signal;
incorporating the radio identification tag into the covering such that the predetermined signal provided by said radio frequency identification tag is emitted when said covering is intact but is not provided or is modified when the integrity of the covering has been breached.

19. A method of remotely determining the integrity of a package as defined in claim 18 wherein the step of providing a radio frequency identification tag comprises providing an identification tag that emits a predetermined response signal to a radio frequency interrogation signal.

20. A method of remotely determining the integrity of a package as defined in claim 18 where the step of incorporating the radio identification tag into the covering comprises incorporating a conductive material onto the covering that provides a conductive electrical path necessary to the functioning of the radio identification tag.

21. A method of remotely determining the integrity of a package as defined in claim 20 wherein the step of incorporating a conductive material comprises applying a conductive adhesive to the covering.

22. A method of remotely determining the integrity of a package as defined in claim 21 where the package has at least a pair of flaps adapted to be oriented contiguous to each other and the step of incorporating a conductive adhesive comprises applying a portion of the conductive adhesive to each of the at least two flaps so as to provide a conductive electrical circuit between each of said at least two flaps when in the contiguous orientation.

23. A method of remotely determining the integrity of a package as defined in claim 18 wherein the step of providing a radio frequency tag having a plurality of components comprises providing a radio identification tag having at least an antenna.

24. A method of remotely determining the integrity of a package as defined in claim 23 wherein the step of providing at least an antenna comprises printing the antenna on to the covering.
